(19) United States
(12) Patent Application Publication
(10) Pub. No.: US 2025/0125568 A1
(43) Pub. Date: Apr. 17, 2025

(54) ELECTRICAL TERMINAL WITH AN INNER FERRULE HAVING ENHANCED RETENTION FEATURES

(71) Applicant: Aptiv Technologies AG, Schaffhausen (CH)

(72) Inventors: John MORELLO, Warren, OH (US); James RAINEY, Warren, OH (US); Ryan KIRKPATRICK, Cranberry, PA (US); Michael BARTON, Ravenna, OH (US)

(21) Appl. No.: 18/380,975

(22) Filed: Oct. 17, 2023

(51) Int. Cl. H01R 24/40; H01R 43/04; H01R 103/00

(52) U.S. Cl. CPC H01R 24/40; H01R 43/04; H01R 2103/00

(57) ABSTRACT

An electrical terminal includes a cylindrical inner ferrule having a first portion and a second portion separated by at least one seam therebetween. An inner surface of the first portion and/or second portion defines a gripping feature that is configured to deform a cylindrical dielectric layer surrounding an electrical conductor of an electrical cable. The electrical terminal also includes a cylindrical outer ferrule surrounding the inner ferrule. A method of assembling an electrical cable is also presented.

### TECHNICAL FIELD OF THE INVENTION

The invention generally relates to electrical terminals, and more particularly to an electrical terminal with an inner ferrule having enhanced retention features.

### BACKGROUND

Electrical terminals, such as those attached to coaxial wire cables, have inner ferrules that are knurled on their outside surface to provide a high friction interface between the inner ferrule and the shield conductor of the coaxial cable surrounding the inner ferrule in order to increase the axial retention force of the inner ferrule to the coaxial cable. However, as shown in FIG. 1, the inner surface of the inner ferrule is smooth and does not significantly increase the axial retention force of the inner ferrule to the coaxial cable.

Other electrical terminal designs have an inner ferrule that is folded under the shield conductor in order to increase the axial retention force of the inner ferrule to the coaxial cable. This second inner ferrule design requires a more complicated manufacturing process to assemble the electrical terminal.

### SUMMARY

In some aspects, the techniques described herein relate to an electrical terminal, including: a cylindrical inner ferrule having a first portion and a second portion separated by a seam therebetween. An inner surface of the first portion and/or second portion defines a gripping feature that is configured to deform a cylindrical dielectric layer surrounding an electrical conductor of an electrical cable. The electrical terminal also includes a cylindrical outer ferrule surrounding the inner ferrule.

In some aspects, the techniques described herein relate to a method of assembling an electrical cable, including the steps of:
forming gripping features in a surface of a sheet metal preform;
forming a cylindrical inner ferrule having a first portion and a second portion separated by a seam from the sheet metal preform such that gripping features are defined by an inner surface of the inner ferrule;
placing the inner ferrule over a cylindrical dielectric layer surrounding an electrical conductor of an electrical cable;
closing the seam such that portions of the seam are less than or equal to 0.1 millimeters wide, thereby forming two seams between the first and second portions; deforming the cylindrical dielectric layer using the gripping features as the seam is closed; and
placing a cylindrical outer ferrule around the inner ferrule.

### BRIEF DESCRIPTION OF THE DRAWINGS

The present invention will now be described, by way of example with reference to the accompanying drawings, in which:

FIG. 1 is cross-section view of an electrical terminal in accordance with the prior art.

FIG. 2 is an isometric view of an electrical terminal in accordance with some embodiments of the invention.

FIG. 3 is an isometric view of a shield terminal of the electrical terminal of FIG. 2 in accordance with some embodiments of the invention.

FIG. 4 is cross-section view of the shield terminal of FIG. 3 in accordance with some embodiments of the invention.

FIG. 5 is an end view of the shield terminal of FIG. 3 in an opened condition in accordance with some embodiments of the invention.

FIG. 6 is an end view of the shield terminal of FIG. 3 in a closed condition in accordance with some embodiments of the invention.

FIG. 7 is a cross-section view of the electrical terminal of FIG. 2 in accordance with some embodiments of the invention.

FIG. 8 is an enlarged view of a portion of FIG. 7 in accordance with some embodiments of the invention.

FIG. 9 is a flow chart of a method of assembling an electrical cable in accordance with some embodiments of the invention.

FIG. 10 is a top view of a sheet metal preform used to form the shield terminal of FIG. 3 in accordance with some embodiments of the invention.

### DETAILED DESCRIPTION

Nonlimiting examples of an electrical terminal configured to terminate an electrical cable are shown in FIGS. 2-8. In some embodiments, the electrical terminal is a coaxial cable terminal 200.

As illustrated in FIG. 2, the coaxial cable terminal 200 is configured to terminate an electrical cable 206. In the embodiment shown in FIG. 2, the electrical cable 206 is a coaxial cable, but in other embodiments the electrical terminal may be configured to terminate other types of cables. In some embodiments, coaxial cable terminal 200 includes a shield terminal 202 that is attached to the shield conductor 204 of the coaxial cable 206 by a cylindrical inner ferrule 208 that is a part of the shield terminal 202 and a separate cylindrical outer ferrule 210. The outer ferrule 210 surrounds the inner ferrule 208 and is crimped to the coaxial cable 206 over the inner ferrule 208 to secure the coaxial cable terminal 200 to the coaxial cable 206. As described in more detail below, it is desirable that the interaction of the shield terminal 202 and the coaxial cable 206 provide an axial retention force F that must be overcome to separate the coaxial cable terminal 200 from the coaxial cable 206.

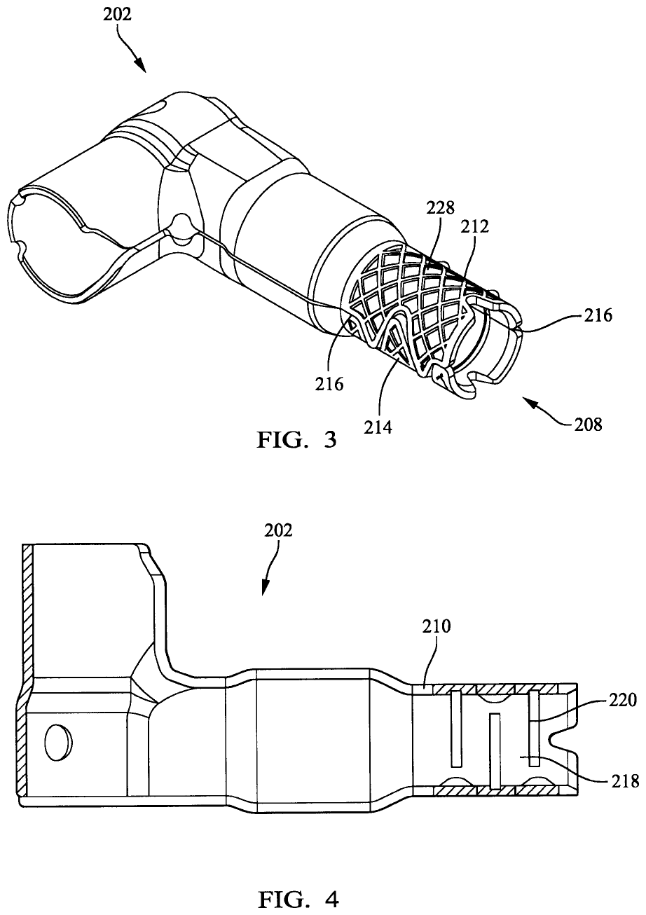

As shown in FIG. 3, the cylindrical outer ferrule 210 has been removed to allow the cylindrical inner ferrule 208 of the coaxial cable terminal 200 to be visible. As shown in FIG. 3, the inner ferrule 208 has a first portion 212 and a second portion 214 that are separated by at least one seam 216. In the embodiment shown, the inner ferrule 208 includes two seams 216 that are approximately 180 degrees apart. An inner surface 218 of the first portion 212 and/or second portion 214 defines one or more gripping features 220 (visible in the cross-sectional view shown in FIG. 4) that are configured to deform a cylindrical dielectric layer 222 surrounding a central electrical conductor 224 of the coaxial cable 206, thereby increasing an axial retention force F that must be overcome to separate the coaxial cable terminal 200 from the coaxial cable 206.

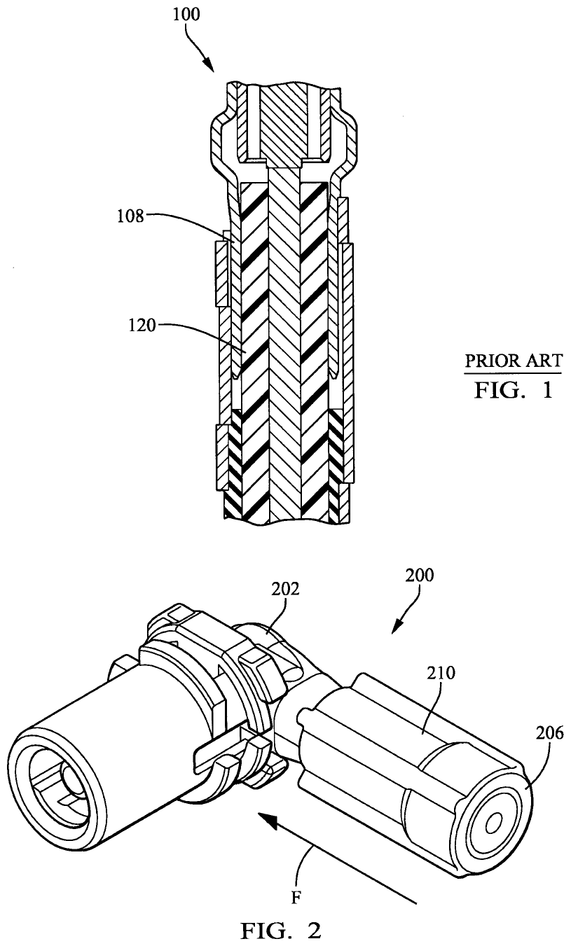

FIG. 4 is a cross-sectional view of the coaxial cable terminal 200 that illustrates the gripping features 220 located on the inner surface 218 of the cylindrical inner ferrule 208. In the cross-sectional view shown in FIG. 4 the coaxial cable 206 is not present, allowing the gripping features 220 to be visible in this view. The gripping features 220 of the example shown in FIG. 4 are a plurality of negative radial grooves that are circumferentially and axially offset from one another. The gripping feature 220 provides the benefit of displacing the dielectric layer 222 (for example, shown in FIG. 7) when the inner ferrule 208 is attached to the coaxial cable 206 to create a retention interaction. In some embodiments, when the inner ferrule 208 is compressed around the dielectric layer 222 of the coaxial cable 206, the gripping feature 220 will act as a relief pocket into which the dielectric material of the dielectric layer 222 flows. The gripping feature 220 provides the inner ferrule 208 with geometry that will cause the axial retention force F that must be overcome to pull the coaxial cable terminal 200 from the coaxial cable 206 to be higher than an axial retention force when there are two smooth interfacing surfaces on the inner ferrule 108 and the dielectric layer 120 of the coaxial cable as shown in FIG. 1. By adding the gripping feature 220 to the interface between the inner surface 218 of the inner ferrule 208 and the dielectric layer 222, the shield conductor 204/inner ferrule 208 interface is no longer the only source of mechanical retention strength.

In some embodiments, the gripping features 220 are negative gripping features that are formed in the inner surface 218 of the inner ferrule 208 which may include one or more radial grooves, depressions, indentations, dimples, notches, serrations, concavities, and/or knurling formed in an inner wall of the inner ferrule. In some embodiments, the gripping features 220 are positive gripping features formed in the inner surface 218 of the inner ferrule 208 which may include one or more radial ribs, protrusions, projections, convexities, bumps, and/or barbs extending from the inner wall of the inner ferrule. These lists of negative and positive gripping features are not exhaustive.

In some embodiments, the inner ferrule 208 and the gripping feature 220 are sized, shaped and arranged such that a minimum diameter of the inner surface 218 of the first and second portions 212, 214 is less than a diameter of the dielectric layer 222 of the coaxial cable 206 when edges 226 of the first and second portions 212, 214 are drawn together, thereby closing or minimizing the seams 216 as shown in FIG. 6. This causes portions of the dielectric layer 222 to be deformed or extruded, thereby increasing friction between the inner ferrule 208 and the dielectric layer 222 and consequently increasing the axial retention force F needed to be overcome to separate the inner ferrule 208 from the coaxial cable 206.

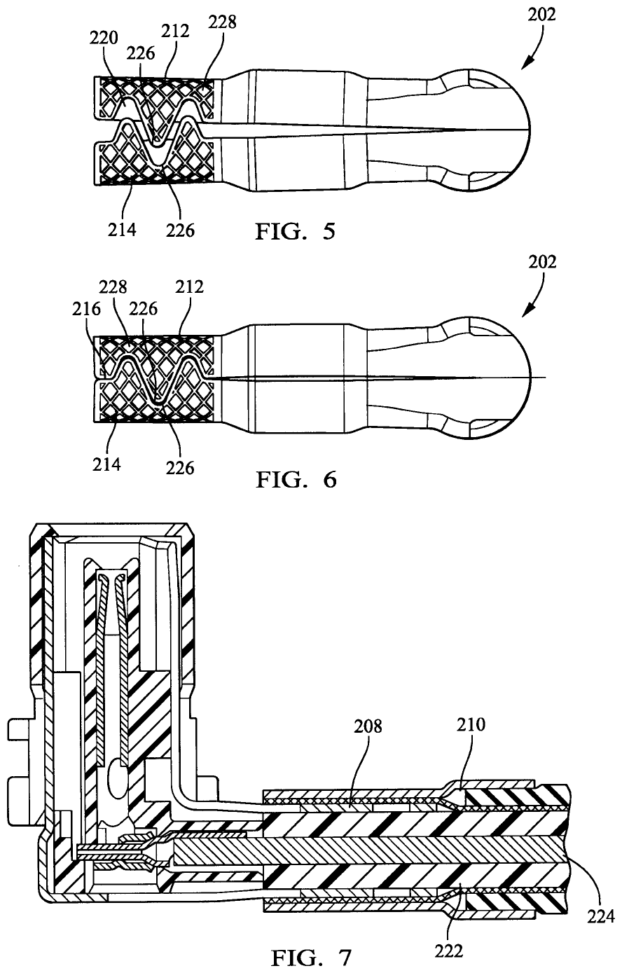

As can be seen in FIGS. 5 and 6, in some embodiments the first and second portions 212, 214 of the inner ferrule 208 are integrally formed with one another and with the shield terminal 202 of the coaxial cable terminal 200. The two seams 216 may be open as shown in FIG. 5 when the inner ferrule 208 is placed over the dielectric layer 222 of the coaxial cable 206. When the seams 216 are closed or minimized as shown in FIG. 6, the two seams 216 between the first and second portions 212, 214 of the inner ferrule 208 are less than or equal to 0.1 millimeters wide as the first and second portions 212, 214 are drawn together, thereby gripping the dielectric layer 222. The outer ferrule 210, when crimped around the inner ferrule 208, keeps the two seams 216 in the closed condition shown in FIG. 6.

As best shown in FIG. 6, in some embodiments, the shape of edges 226 of the first and second portions 212, 214 are mirrored and congruent. The edges 226 of the first and second portions 212, 214 follow complimentary serpentine paths. In some embodiments, after the first and second portions 212, 214 are drawn together and secured by the outer ferrule 210, portions of edges 226 of the first and second portions 212, 214 are less than or equal to 0.1 millimeters apart. In some embodiments, these serpentine edges 226 form teeth and indentations that contact one another to limit the compression of the dielectric layer 222, thereby reducing impedance irregularities in the coaxial cable terminal 200 that would negatively impact its high frequency electrical performance.

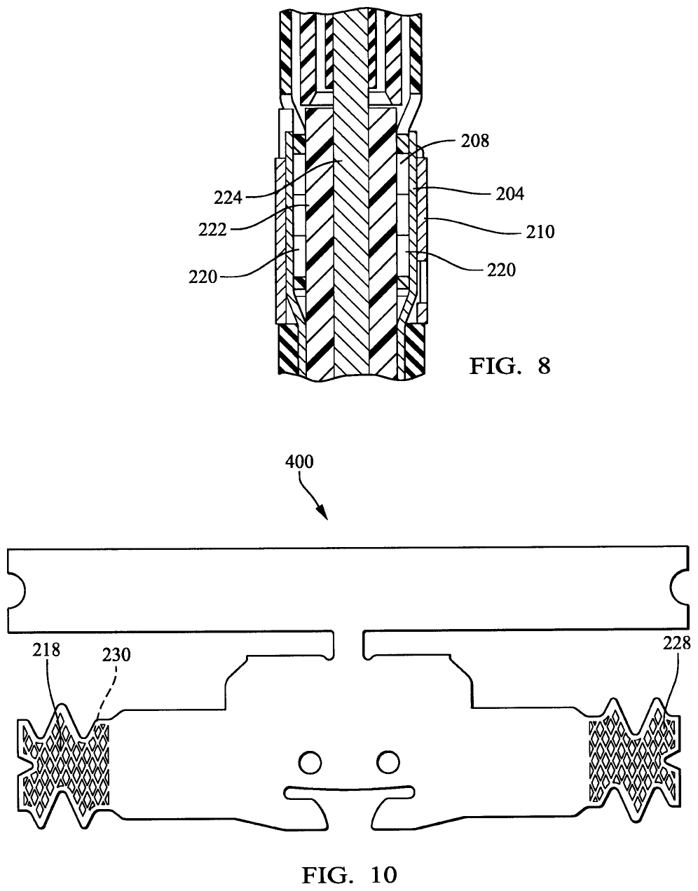

In some embodiments, the inner ferrule 208 has two seams 216 that allow the inner ferrule 208 to open to easily accept the dielectric layer 222 but also allow the inner ferrule 208 to be closed down to a smaller, consistent diameter. Compressing the inner ferrule 208 having two seams 216 around a soft material, such as the dielectric layer 222 of the coaxial cable 206, causes the dielectric layer 222 to extrude into the negative gripping features 220 more uniformly as shown in FIG. 8, thereby increasing friction between the inner ferrule 208 and the dielectric layer 222. In other embodiments, compressing the inner ferrule 208 having two seams 216 around a soft material, such as the dielectric layer 222 of the coaxial cable 206, causes the positive gripping features 220 to more uniformly deform the dielectric layer 222, thereby also increasing friction between the inner ferrule 208 and the dielectric layer 222. Alternative embodiments of the inner ferrule may be envisioned that have a single seam rather than two seams 216.

In some embodiments, an outer surface 230 of the inner ferrule 208 is knurled 228 as shown in FIG. 3 to improve electrical conductivity between the inner ferrule 208 and the shield conductor 204 of the coaxial cable 206 as well as further increase the axial retention force F.

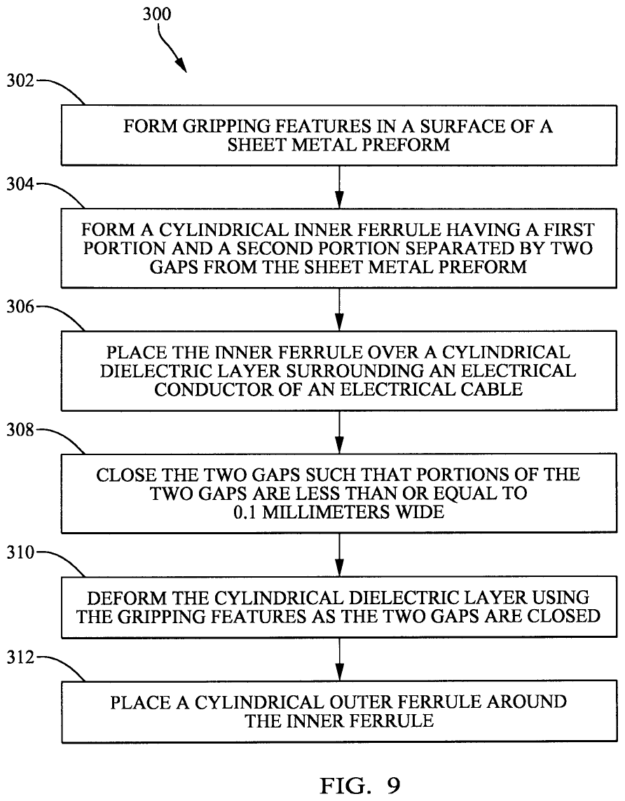

FIG. 9 presents a flow chart of a method 300 of assembling an electrical cable. At step 302, gripping features 220 are formed in a surface of a sheet metal preform 400. For example, FIG. 10 illustrates a sheet metal preform 400 of what will be formed into the cylindrical inner ferrule 208. In some embodiments, the gripping features 220 are formed by negative gripping features in the inner surface 218 of the inner ferrule 208 which may include one or more radial grooves, depressions, indentations, dimples, notches, serrations, concavities, and/or knurling formed in an inner wall of the inner ferrule 208. In some embodiments, the gripping features 220 are positive gripping features formed in the inner surface 218 of the inner ferrule 208 which may include one or more radial ribs, protrusions, projections, convexities, bumps, and/or barbs extending from the inner wall of the inner ferrule 208. These lists of negative and positive gripping features are not exhaustive.

At step 304, the cylindrical inner ferrule 208 as shown in FIG. 3 having a first portion 212 and a second portion 214 separated by a seam is formed from the sheet metal preform 400 such that the gripping features 220 are defined by an inner surface 218 of the inner ferrule 208. At step 306, the inner ferrule 208 is placed over a dielectric layer 222 surrounding an electrical conductor 224 of a coaxial cable 206 as shown in FIG. 7.

At step 308, the seam provided between the first portion 212 and the second portion 214 of the cylindrical inner ferrule 208 is closed such that portions of the seam are less than or equal to 0.1 millimeters wide as shown in FIG. 6. The result is the formation of two seams 216 between the first and second portions 212, 214.

At step 310, the dielectric layer 222 is deformed by the application of force applied as a seam are closed as shown in FIG. 8. In some embodiments, the deformation of the dielectric layer 222 is a result of the dielectric layer 222 flowing into the negative gripping features 220 located on the inner surface of the cylindrical inner ferrule 208. In some embodiments, the deformation of the dielectric layer 222 is a result of the dielectric layer 222 being deformed by the positive gripping features 220 located on the inner surface of the cylindrical inner ferrule 208.

At step 312, the cylindrical outer ferrule 210 is placed around the inner ferrule 208 as shown in FIG. 8 to compress the inner ferrule 208.

While the illustrated examples pertain to a coaxial cable terminal 200 for a coaxial cable 206, other embodiments of electrical terminals may be envisioned that are configured for other types of electrical cables, such as a shieled twisted pair cable or any other cable type in which an inner and outer ferrule to secure the electrical terminal to the cable is desired.

In some aspects, the techniques described herein relate to an electrical terminal, including: a cylindrical inner ferrule having a first portion and a second portion separated by two seams therebetween. An inner surface of the first portion and/or second portion defines a gripping feature that is configured to deform a cylindrical dielectric layer surrounding an electrical conductor of an electrical cable. The electrical terminal also includes a cylindrical outer ferrule surrounding the inner ferrule.

In some aspects, the techniques described herein relate to an electrical terminal, wherein the gripping feature is a negative gripping feature selected from a list consisting of radial grooves, depressions, indentations, dimples, notches, serrations, concavities, and knurling.

In some aspects, the techniques described herein relate to an electrical terminal, wherein the gripping feature is a positive gripping feature selected from a list consisting of radial ribs, protrusions, projections, convexities, bumps, and barbs.

In some aspects, the techniques described herein relate to an electrical terminal, wherein the first and second portions are integrally formed with one another.

In some aspects, the techniques described herein relate to an electrical terminal, wherein the first and second portions are integrally formed with a shield terminal of the electrical terminal.

In some aspects, the techniques described herein relate to an electrical terminal, wherein the electrical cable is a coaxial cable.

In some aspects, the techniques described herein relate to an electrical terminal, wherein a minimum diameter of joined inner surfaces of the first and second portions is less than a diameter of the cylindrical dielectric layer.

In some aspects, the techniques described herein relate to an electrical terminal, wherein edges of the first and second portions are mirrored and congruent.

In some aspects, the techniques described herein relate to an electrical terminal, wherein edges of the first and second portions follow complimentary serpentine paths.

In some aspects, the techniques described herein relate to an electrical terminal, wherein portions of edges of the first and second portions interface to limit deformation of the dielectric layer.

In some aspects, the techniques described herein relate to an electrical terminal, wherein an outer surface of the inner ferrule is knurled.

In some aspects, the techniques described herein relate to a method of assembling an electrical cable, including the steps of:
forming gripping features in a surface of a sheet metal preform;
forming a cylindrical inner ferrule having a first portion and a second portion separated by a seam from the sheet metal preform such that gripping features are defined by an inner surface of the inner ferrule;
placing the inner ferrule over a cylindrical dielectric layer surrounding an electrical conductor of an electrical cable;
closing the seam such that portions of the seam are less than or equal to 0.1 millimeters wide, thereby forming two seams between the first and second portions; deforming the cylindrical dielectric layer using the gripping features as the seam is closed; and.
placing a cylindrical outer ferrule around the inner ferrule.

In some aspects, the techniques described herein relate to a method, wherein the gripping features are negative gripping features selected from a list consisting of radial grooves, depressions, indentations, dimples, notches, serrations, concavities, and knurling.

In some aspects, the techniques described herein relate to a method, wherein the gripping features are positive gripping features selected from a list consisting of radial ribs, protrusions, projections, convexities, bumps, and barbs.

In some aspects, the techniques described herein relate to a method, wherein the first portion is integrally formed with the second portion.

In some aspects, the techniques described herein relate to a method, further including: limiting deformation of the dielectric layer due to an interface of edges of the first and second portions.

In some aspects, the techniques described herein relate to a method, wherein the electrical cable is a coaxial cable.

In some aspects, the techniques described herein relate to a method, wherein a diameter of the cylindrical dielectric layer is greater than a minimum diameter of joined inner surfaces of the first and second portions prior to the step of closing the seam.

In some aspects, the techniques described herein relate to a method, wherein edges of the first and second portions are mirrored and congruent.

In some aspects, the techniques described herein relate to a method, wherein edges of the first and second portions follow complimentary serpentine paths.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

We claim:

1. An electrical terminal, comprising:
a cylindrical inner ferrule having a first portion and a second portion separated by at least one seam therebetween, wherein an inner surface of the first portion and/or the second portion defines a gripping feature configured to deform a cylindrical dielectric layer surrounding an electrical conductor of an electrical cable; and
a cylindrical outer ferrule surrounding the inner ferrule.

2. The electrical terminal according to claim 1, wherein the gripping feature is a negative gripping feature selected from a list consisting of radial grooves, depressions, indentations, dimples, notches, serrations, concavities, and knurling.

3. The electrical terminal according to claim 1, wherein the gripping feature is a positive gripping feature selected from a list consisting of radial ribs, protrusions, projections, convexities, bumps, and barbs.

4. The electrical terminal according to claim 1, wherein the first and second portions are integrally formed with one another.

5. The electrical terminal according to claim 1, wherein the first and second portions are integrally formed with a shield terminal of the electrical terminal.

6. The electrical terminal according to claim 1, wherein the electrical cable is a coaxial cable.

7. The electrical terminal according to claim 1, wherein a minimum diameter of joined inner surfaces of the first and second portions is less than a diameter of the cylindrical dielectric layer.

8. The electrical terminal according to claim 1, wherein edges of the first and second portions are mirrored and congruent.

9. The electrical terminal according to claim 1, wherein edges of the first and second portions follow complimentary serpentine paths.

10. The electrical terminal according to claim 1, wherein portions of edges of the first and second portions are configured to limit deformation of the dielectric layer.

11. The electrical terminal according to claim 1, wherein an outer surface of the inner ferrule is knurled.

12. A method of assembling an electrical cable, comprising:
forming gripping features in a surface of a sheet metal preform;
forming a cylindrical inner ferrule having a first portion and a second portion separated by a seam from the sheet metal preform such that gripping features are defined by an inner surface of the inner ferrule;
placing the inner ferrule over a cylindrical dielectric layer surrounding an electrical conductor of an electrical cable;
closing the seam such that portions of the seam are less than or equal to 0.1 millimeters wide, thereby forming two seams between the first and second portions;
deforming the cylindrical dielectric layer using the gripping features as the seam is closed; and
placing a cylindrical outer ferrule around the inner ferrule.

13. The method according to claim 12, wherein the gripping features are negative gripping features selected from a list consisting of radial grooves, depressions, indentations, dimples, notches, serrations, concavities, and knurling.

14. The method according to claim 12, wherein the gripping features are positive gripping features selected from a list consisting of radial ribs, protrusions, projections, convexities, bumps, and barbs.

15. The method according to claim 12, wherein the first portion is integrally formed with the second portion.

16. The method according to claim 12, further comprising: limiting deformation of the dielectric layer due to an interface of edges of the first and second portions.

17. The method according to claim 12, wherein the electrical cable is a coaxial cable.

18. The method according to claim 12, wherein a diameter of the cylindrical dielectric layer is greater than a minimum diameter of joined inner surfaces of the first and second portions prior to the step of closing the seam.

19. The method according to claim 12, wherein edges of the first and second portions are mirrored and congruent.

20. The method according to claim 12, wherein edges of the first and second portions follow complimentary serpentine paths.
